(19) United States
(12) Patent Application Publication
(10) Pub. No.: US 2023/0282852 A1
(43) Pub. Date: Sep. 7, 2023

(54) Shared Pressure Vessel Metal Hydrogen Battery

(71) Applicant: EnerVenue, Inc, Fremont, CA (US)

(72) Inventors: Majid Keshavarz, Pleasanton, CA (US); Ge Zu, San Jose, CA (US)

(21) Appl. No.: 18/177,602

(22) Filed: Mar. 2, 2023

Related U.S. Application Data
(60) Provisional application No. 63/316,591, filed on Mar. 4, 2022.

(51) Int. Cl. H01M 8/04746; H01M 12/08; H01M 8/04111

(52) U.S. Cl. CPC H01M 8/04753; H01M 12/08; H01M 8/04111

(57) ABSTRACT

In accordance with embodiments of this disclosure a shared pressure vessel metal hydrogen battery is disclosed. A metal hydrogen battery according to some embodiments includes one or more pressure vessels, each of the one or more pressure vessels including one or more electrode stacks, and each of the one or more pressure vessels including a fill tube; a manifold coupled to the fill tube of each of the one or more pressure vessels, the manifold including a control device; and a storage vessel coupled to the control device, wherein hydrogen gas stored in the storage vessel is supplied to the one or more pressure vessels through the manifold and the control device.

### RELATED APPLICATION

This disclosure claims priority to U.S. Provisional Appl. 63/316,591, filed on Mar. 4, 2022, which is herein incorporated by reference in its entirety.

### TECHNICAL FIELD

Embodiments of the present invention are related to metal-hydrogen batteries and, in particular, to shared pressure vessel configurations of metal-hydrogen batteries.

### DISCUSSION OF RELATED ART

For renewable energy resources such as wind and solar to be competitive with traditional fossil fuels, large-scale energy storage systems are needed to mitigate their intrinsic intermittency. To build a large-scale energy storage, the cost and long-term lifetime are the utmost considerations. Currently, pumped-hydroelectric storage dominates the grid energy storage market because it is an inexpensive way to store large quantities of energy over a long period of time (about 50 years), but it is constrained by the lack of suitable sites and the environmental footprint. Other technologies such as compressed air and flywheel energy storage show some different advantages, but their relatively low efficiency and high cost should be significantly improved for grid storage. Rechargeable batteries offer great opportunities to target low-cost, high capacity and highly reliable systems for large-scale energy storage. Improving reliability of rechargeable batteries has become an important issue to realize a large-scale energy storage.

Consequently, there is a need for better metal-hydrogen battery configurations.

### SUMMARY

In accordance with embodiments of this disclosure a shared pressure vessel metal hydrogen battery is disclosed. A metal hydrogen battery according to some embodiments includes one or more pressure vessels, each of the one or more pressure vessels including one or more electrode stacks, and each of the one or more pressure vessels including a fill tube; a manifold coupled to the fill tube of each of the one or more pressure vessels, the manifold including a control device; and a storage vessel coupled to the control device, wherein hydrogen gas stored in the storage vessel is supplied to the one or more pressure vessels through the manifold and the control device.

These and other embodiments are discussed below with respect to the following figures.

### BRIEF DESCRIPTION OF THE FIGURES

An understanding of the features and advantages of the technology described in this disclosure will be obtained by reference to the following detailed description that sets forth illustrative aspects with reference to the following figures.

FIG. 1 illustrates an example of a metal-hydrogen battery according to some aspects of the present disclosure.

FIG. 2 illustrates an example of a metal-hydrogen battery with a shared pressure vessel configuration according to some embodiments.

FIG. 3 illustrates another example of a metal-hydrogen battery with a shared pressure vessel configuration according to some embodiments.

FIG. 4 illustrates another example of a metal-hydrogen battery with a shared pressure vessel configuration according to some embodiments.

These figures are further discussed below.

### DETAILED DESCRIPTION

In the following description, specific details are set forth describing some aspects of the present invention. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. Such modifications may include substitution of known equivalents for any aspect of the disclosure in order to achieve the same result in substantially the same way.

Consequently, this description illustrates inventive aspects and embodiments that should not be taken as limiting—the claims define the protected invention. Various changes may be made without departing from the spirit and scope of this description and the claims. In some instances, well-known structures and techniques have not been shown or described in detail in order not to obscure the invention.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Further, individual values provided for particular components are for example only and are not considered to be limiting. Specific dimensional values for various components are there to provide a specific example only and one skilled in the art will recognize that the aspects of this disclosure can be provided with any dimensions. Additionally, the singular forms “a,” “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

In the figures, relative sizes of components are not meaningful unless stated otherwise and should not be considered limiting. Components are sized in the figures to better describe various features and structures without consideration of the displayed sizes with respect to other components. Further, although specific dimensions to describe one example of a battery, those specific dimensions are provided as an example only and are not limiting. Batteries according to aspects of the following disclosure can be formed having any dimensions with components having any relative dimensions.

Metal-hydrogen batteries can be configured in a number of ways. In each case, the battery itself includes one or more electrode stacks, each with a series of electrodes (alternating layers of cathode material and anode material) separated by electrically isolating separators. The electrode stacks, which are saturated with an electrolyte, are housed in one or more pressure vessels. The electrode stacks can provide arrays of cells (i.e., pairs of cathode and anode electrodes) that can be electrically coupled in series or in parallel. Each electrode stack can be arranged such that the cells formed in the array of electrodes are coupled in parallel. In accordance with embodiments of the present disclosure, pressure vessels that each contain one or more electrode layers can be coupled to a central storage tank to form a shared pressure vessel configuration.

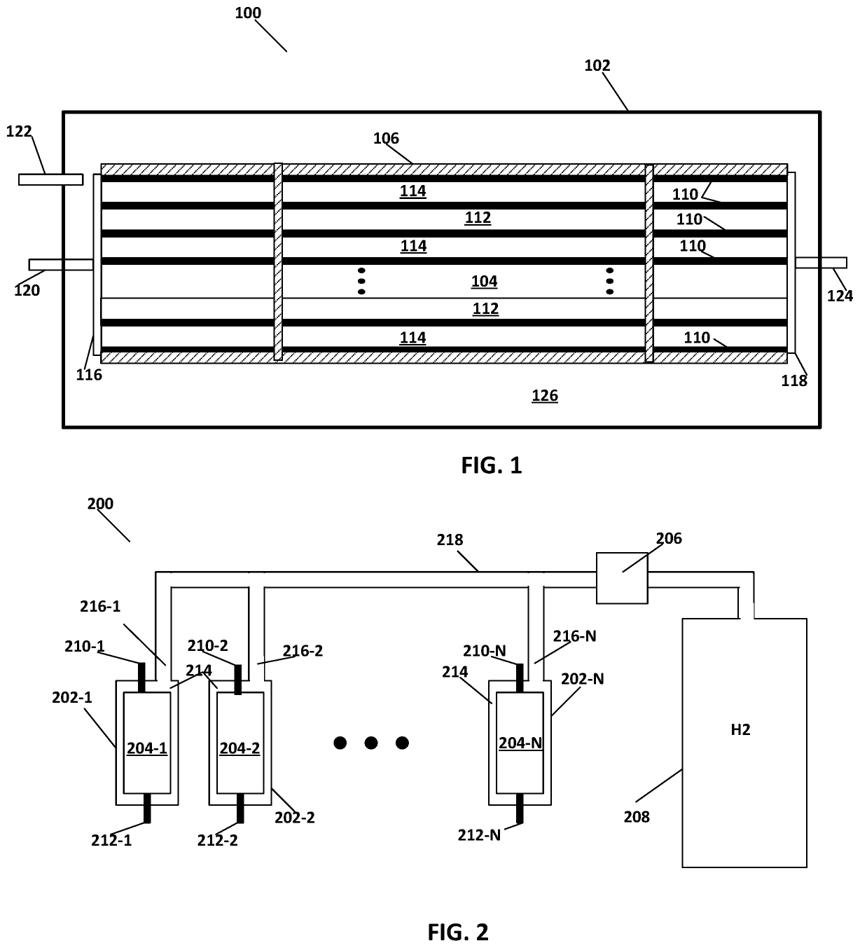

FIG. 1 depicts a schematic depiction of a metal-hydrogen battery 100 according to some aspects of the present disclosure. The metal-hydrogen battery 100 illustrated in FIG. 1 includes electrode stack assembly 104 that includes stacked electrodes separated by separators 110. Some examples of electrode stack assemblies such as electrode stack assembly 104 are further described in U.S. patent application Ser. No. 17/687,527, entitled “Electrode Stack Assembly for a Metal Hydrogen Battery,” filed on Mar. 4, 2022; and U.S. patent application Ser. No. 17/830,193, entitled “Electrode Stack Assembly for a Metal Hydrogen Battery,” filed on Jun. 1, 2022, each of which is herein incorporated by reference in their entirety.

The electrodes in electrode stack assembly 104 include cathodes 112, anodes 114. Separator 110 is disposed between the cathode 112 and the anode 114. Each pair of cathode 112 and anode 114 electrodes can be considered a cell. The electrode stack 104 can further include a frame 106 that fixes the cathodes 112, anodes 114, and separators 110 in place. In the particular example illustrated in FIG. 1, there is an anode 114 on both the top and bottom of stack 104, adjacent to frame 106, however other arrangements can also be formed.

The electrode stack assembly 104 can be housed in a pressure vessel 102. An electrolyte 126 is also disposed in pressure vessel 102. The cathode 112, the anode 114, and the separator 110 are porous to allow electrolyte 126 to flow between the cathode 112 and the anode 114. In some embodiments, the separator 110 can be omitted as long as the cathode 112 and the anode 114 can be electrically isolated from each other. For example, the space occupied by the separator 110 may be filled with the electrolyte 126. The metal-hydrogen battery 100 can further include a fill tube 122 configured to introduce electrolyte or gasses (e.g., hydrogen) into pressure vessel 102. In embodiments of the present disclosure, as discussed below, fill tube 122 can be coupled to a gas manifold that is further connected to a storage vessel so that hydrogen gas can be exchanged between pressure vessel 102 and the storage vessel.

As shown in FIG. 1, electrode stack assembly 104 includes a number of stacked layers of alternating cathode 112 and anode 114 separated by a separate 110. Cells can be formed by pairs of cathode 112 and anode 114 layers. Although the cells in an electrode stack assembly 104 may be coupled either in parallel or in series, in the example of battery 100 illustrated in FIG. 1 the cells are coupled in parallel. In particular, each of cathodes 112 are coupled to a conductor 118 and each of anodes 114 are coupled to conductor 116. Although FIG. 1 illustrates that fill tube 122 is positioned on the side of anode conductor 116, it may alternatively be placed on the side of cathode conductor 118, or in the side wall of pressure vessel 102.

Additionally, in the example of FIG. 1, pressure vessel 102 is illustrated as a cylindrical vessel. In general, pressure vessel 102 can be any shape large enough to receive electrode stack 104 and hold the pressures involved during operation. Further, in FIG. 1 electrode stack 104 is illustrated as oriented along a length of pressure vessel 102. However, electrode stack 104 can be arranged so that the electrodes are laterally oriented instead. Consequently, electrode stack 104 can be any shape or orientation.

As is further illustrated in FIG. 1, conductor 116, which is coupled to anodes 114, is electrically coupled to an anode feedthrough terminal 120, which may present the negative terminal of battery 100. Terminal 120 can include a feedthrough to allow terminal 120 to extend outside of pressure vessel 102, or conductor 116 may be connected directly to pressure vessel 102. Similarly, cathode conductor 118, which is coupled to cathode 112, can be coupled to a cathode feedthrough terminal 124 that represents the positive side of battery 100. Terminal 124 also pass through an insulated feedthrough to allow terminal 124 to extend to the outside of pressure vessel 102.

As discussed above, each cell included in electrode stack 104 includes a cathode 112 and an anode 114 that are separated by separators 110. Electrode stack 104 is positioned in pressure vessel 102 where an electrolyte 126 can flow between cathode 112 and anode 114. As is discussed further below, cathode 112 is formed of a conductive substrate coated by a metal compound. Similarly, anode 114 is formed of a porous conductive substrate coated by a porous catalyst. Separator 110 is a porous insulator that can separate alternating layers of cathode 112 and anode 114 and allow electrolyte 126 to flow between cathode 112 and anode 114. In some embodiments, the electrolyte 126 is an aqueous electrolyte that is alkaline (with a pH greater than 7). Each of anode 114 and cathode 112 can be formed as electrode assemblies with multiply layered structures, as is discussed further below.

Electrode stack assembly 104, the core of battery 100, operates chemically to charge and discharge battery 100 through a hydrogen evolution reaction (HER) and a hydrogen oxidation reaction (HOR). These reactions are more mechanistically complex in alkaline conditions than in acidic conditions. Active alkaline HER/HOR catalysts tend to have more dynamic surfaces. In acidic conditions, the reactions proceed via the reduction of H⁺ to H₂ or the oxidation of H₂ to H⁺. The activity of a catalyst for these reactions in acidic conditions can be closely correlated to the binding energy of hydrogen to the metal surface. If hydrogen binds too strongly or too weakly, the catalytic process cannot effectively proceed and the kinetic overpotential will be large. Platinum has an ideal binding energy for hydrogen and demonstrates better HER/HOR performance than any other catalyst in low pH solutions. In alkaline conditions, the concentration of free H⁺ is essentially zero, and thus the HER first proceeds via the cleavage of the H—O bond of a water molecule to generate a surface-adsorbed hydrogen atom and a hydroxide anion according to Eq. 1 below. This step is slow on metal surfaces, resulting in alkaline HER exchange current densities that are two to three orders of magnitude smaller than in acid on the same metal. Hydrogen gas is generated according to Eq. 2 or Eq. 3 below. This step (Eq. 1) occurs in reverse as the last step of HOR and is also rate determining as metal surfaces do not interact strongly with the hydroxide anions required to complete the reaction and form H₂O.

H₂O+M+e−→MH_{ad}+OH⁻ Eq. 1

MH_{ad}+H₂O+e−→M+H₂+OH⁻ Eq. 2

MH_{ad}+MH_{ad}→2M+H₂ Eq. 3

To expedite both HER and HOR on the catalyst, a catalyst material is provided that contains (i) metal sites to bind with hydrogen and (ii) metal oxide/metal hydroxide sites to bind with hydroxide anions. The interfaces where metal and metal oxide meet are highly active for both HER and HOR and an optimal ratio of metal-to-metal oxide is maintained to achieve high catalyst activity. If the catalyst surface becomes too oxidized during prolonged, or high overpotential, HOR, the catalyst surface can become deactivated and the battery performance will suffer as a result.

Accordingly, anode 114 is a catalytic hydrogen electrode. In some embodiments, as discussed above, anode 114 includes a porous conductive substrate with a catalyst layer covering the porous conductive substrate. The catalyst layer of anode 114 can cover the outer surface of the porous conductive substrate of anode 114 and, since the porous conductive substrate has internal pores or interconnected channels, can also cover the surfaces of those pores and channels. The catalyst layer includes a bi-functional catalyst to catalyze both hydrogen evolution reaction and hydrogen oxidation reaction at anode 114. In some embodiments, the porous conductive substrate of anode 114 can have a porosity of at least about 10%, at least about 20%, at least about 30%, at least about 40%, or at least about 50%, and up to about 80%, up to about 90%, up to about 95% or greater. In some embodiments, the porous conductive substrate of anode 114 can be a metal foam, such as a nickel foam, a copper foam, a steel foam, an aluminum foam, or others. In some embodiments, the porous conductive substrate of anode 114 can be a metal alloy foam, such as a nickel-molybdenum foam, a nickel-copper foam, a nickel-cobalt foam, a nickel-tungsten foam, a nickel-silver foam, a nickel-molybdenum-cobalt foam, or others. Other conductive substrates, such as metal foils, metal meshes, and fibrous conductive substrates can be used. In some embodiments, the conductive substrates of anode 114 can be carbon-based materials, such as carbon fibrous paper, carbon cloth, carbon felt, carbon mat, carbon nanotube film, graphite foil, graphite foam, graphite mat, graphene foil, graphene fibers, graphene film, and graphene foam.

Battery 100 illustrated in FIG. 1 can illustrate an independent pressure vessel configuration. If battery 100 illustrates an independent pressure vessel configuration, then pressure vessel 102 is first filled with electrolyte 126 through fill tube 122 and later drained through fill tube 122 before fill tube 122 is sealed. In this configuration, stack 104 needs to be porous enough to hold a sufficient quantity of electrolyte 126 for the operation of battery through the numerous charge/discharge cycles throughout its lifetime. During HER/HOR cycling of battery 100, the pressure within pressure vessel 102 can vary drastically through the charge/discharge cycle (from 50 psi to 2000 psi, for example) as hydrogen is consumed or produced according to Eqs. 1-3 above. Consequently, pressure vessel 102 must be sufficiently strong to withstand the pressure cycles that accompany the cycling of battery 100.

However, in embodiments of the present disclosure, a shared pressure vessel configuration is disclosed. FIG. 2 illustrate a shared pressure vessel (SPV) battery 200 according to some embodiments of the present disclosure. As illustrated in FIG. 2, battery 200 includes a plurality of N pressure vessels 202-1 through 202-N, each of which includes a corresponding one of electrode stacks 204-1 through 204-N. Electrode stacks 204-1 through 204-N can be electrode stack 104 as described above with respect to FIG. 1.

As is further illustrated in FIG. 2, each of pressure vessels 202-1 through 202-N includes a fill tube 216-1 through 216-N, respectively. The number of pressure vessels 202, N, can be any number greater than 1. Each of fill tubes 216-1 through 216-N is coupled to a manifold 218. Manifold 218 can include a control device 206 and is coupled to a shared storage tank 208. Shared storage tank 208 can store hydrogen that can be supplied through manifold 218 to each of pressure vessels 202-1 through 202-N. In some embodiments, shared storage tank 208 can be formed from multiple storage tanks and has sufficient capacity to support charge/discharge cycling of battery 200. In some embodiments, control device 206 can be coupled to provide stored hydrogen to each of pressure vessels 202-1 through 202-N simultaneously or may be configured to provide hydrogen to each of pressure vessels 202-1 through 202-N independently.

Device 206 can be a device that controls the flow of hydrogen between pressure vessels 202-1 through 202-N and storage vessel 208. Device 206 can, for example, be a straight connection, a valve, a regulator, a compressor, or combinations of any of these devices. If device 206 is a compressor, for example, then pressure in storage tank 208 can be higher than that of pressure vessels 202-1 through 202-N. In some embodiments, pressure in each of pressure vessels 202-1 through 202-N can be held relatively constant and at a relatively low pressure (e.g., <50 PSI).

As is further illustrated in FIG. 2, each of pressure vessels 202-1 through 202-N an electrode stack 204-1 through 204-N, respectively. Each of electrode stacks 204-1 through 204-N are coupled to terminals 210-1 through 210-N, respectively, and terminals 212-1 through 212-N, respectively. Consequently, electrode stacks 204-1 through 204-N can be coupled in series, parallel, or combinations of series and parallel configurations to form battery 200.

There are multiple advantages to the configuration illustrated in FIG. 2. First, the operating pressure in each of pressure vessels 202-1 through 202-N can be regulated to a low pressure. In some embodiments, the operating pressure can, as an example, be about 40 PSI or less. Pressure vessels 202-1 through 202-N need only be large enough to contain electrode stacks 204-1 through 204-N. Hydrogen can flow between storage vessel 208 and each of pressure vessels 202-1 through 202-N as needed during operation.

Furthermore, low (e.g., minimum to partial vacuum) operating pressures can be determined for efficient operation of battery 200 and this pressure maintained during operation of battery 200. This pressure can be controlled by device 206 so that hydrogen flows between pressure vessels 202-1 through 202-N and storage vessel 208. Further, during long term storage of battery 200, device 206 can shut off flow of hydrogen so that the internal charge leakage or self-discharge of the charged battery can be minimized or even reduced to zero. Storage vessel 208 can be sized to store sufficient hydrogen so that battery 200 can cycled through a lifetime of charge/discharge cycles. Storage vessel 208 can be maintained at a high pressure if control device 206 includes a compressor. Operating pressures and storage vessel 208 capacity can be arranged to provide for reasonable charging rates (C-rates) for battery 200.

Storage vessel 208 can be formed from any material that supports pressures and volumes of hydrogen gas discussed above. For example, storage vessel 208 can be formed from stainless steel, composite materials, carbon fiber composites, rubber, expandable rubber structures (e.g. balloons or bladders), or any other suitable material.

Since pressure vessels 202-1 through 202-N operate at relatively low operating pressures, as discussed above, pressure vessels 202-1 through 202-N can be formed of lighter weight, less expensive materials. For example, pressure vessels 202-1 through 202-N can be formed of plastics, composites, or rubber instead of metals. Further, feedthroughs for terminals 210 (terminals 210-1 through 210-N) and 212 (terminals 212-1 through 212-N) and seals for fill tubes 216 (fill tubes 216-1 through 216-N) can be more easily and less expensively formed.

In the example illustrated in FIG. 2, each of pressure vessels 202-1 through 202-N includes a corresponding one of electrode stacks 204-1 through 204-N. However, a system can include pressure vessels that contain a plurality of electrode stacks as well.

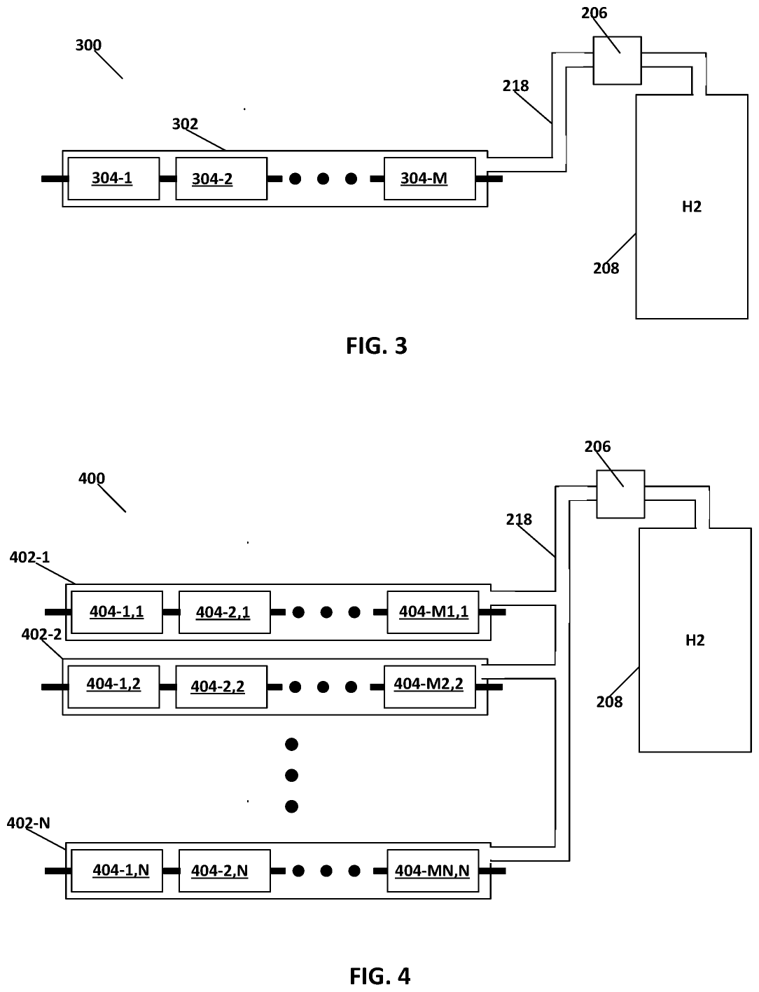

FIG. 3 illustrates a battery 300 that includes pressure vessel 302 that contains a plurality of electrode stacks 304. As is illustrated in FIG. 3, manifold 218 is also coupled to fill tube 306 of pressure vessel 302. Battery 300 can also include the N shared pressure vessels 202-1 through 202-N as illustrated in FIG. 2. Battery 300 may include one or more other pressure vessels similar to pressure vessel 302 as well. In general, any number of pressure vessels 202 and pressure vessels 302 can be included in battery 300.

As is illustrated in FIG. 3, pressure vessel 302 includes a plurality M of electrode stacks 304-1 through 304-M. Each of electrode stacks 304-1 through 304-M can be formed as discussed with electrode stack 104 as illustrated in FIG. 1. In the particular example illustrated in FIG. 3, electrode stacks 304-1 through 304-M are coupled in series, although in some embodiments they may be coupled in parallel or a combination of series and parallel configurations. Since the operating pressure in pressure vessel 302 can be minimal, pressure vessel 302 can be made of light-weight materials and is size limited only by the electrode stacks 304 that are contained within.

FIG. 4 illustrates another configuration of shared pressure vessel battery 400 according to some embodiments of the present disclosure. As illustrated in FIG. 4, N pressure vessels 402-1 through 402-N, each containing one or more electrode stacks 404. As illustrated, pressure vessel 402-1 includes electrode stacks 404-1,1 through 404-M1,1 and pressure vessel 402-N includes electrode stacks 404-1,N through 404-MN,N. In general, any combinations of individual pressure vessels 402 each with any number of electrode stacks 404 connected in series, parallel, or a combination of series and parallel can be used.

As discussed above, therefore, a shared pressure vessel battery can be formed of any number of pressure vessels 202 as illustrated in FIG. 2 and any number of pressure vessels 302 as illustrated in FIG. 3 with fill tubes coupled to a storage vessel 208 through a manifold 218 and control device 206. Hydrogen can then flow between each of pressure vessels 202 and pressure vessels 302 as needed during operation. Further, the operating pressure of each of pressure vessels 202 and pressure vessels 302 can be regulated at a relatively low pressure. Additionally, since all electrode stacks share the same hydrogen source, the state of charge (SOC) of the whole system is easily available, making charge/discharge control much easier. Also, the moisture level for all of the electrode stacks can be regulated through manipulating humidity of the hydrogen gas flow. Finally, charge leakage during storage of the shared pressure vessel battery can be minimized by restricting or turning off the flow of hydrogen from storage vessel 208.

Embodiments of the invention described herein are not intended to be limiting of the invention. One skilled in the art will recognize that numerous variations and modifications within the scope of the present invention are possible. Consequently, the present invention is set forth in the following claims.

What is claimed is:

1. A metal hydrogen battery, comprising:
one or more pressure vessels, each of the one or more pressure vessels including one or more electrode stacks, and each of the one or more pressure vessels including a fill tube;
a manifold coupled to the fill tube of each of the one or more pressure vessels, the manifold including a control device;
a storage vessel coupled to the control device, wherein hydrogen gas stored in the storage vessel is supplied to the one or more pressure vessels through the manifold and the control device.

2. The metal hydrogen battery of claim 1, wherein the control device includes a compressor.

3. The metal hydrogen battery of claim 1, wherein the control device regulates a pressure of the one or more pressure vessels.

4. The metal hydrogen battery of claim 1, wherein the control device includes a valve.

5. The metal hydrogen battery of claim 1, wherein the one or more pressure vessels includes a plurality of pressure vessels, each of the plurality of pressure vessels including a single electrode stack.

6. The metal hydrogen battery of claim 5, wherein the control device is coupled to each of the plurality of pressure vessels.

7. The metal hydrogen battery of claim 1, wherein the one or more pressure vessels includes one pressure vessel, the pressure vessel including a plurality of electrode stacks.

8. The metal hydrogen battery of claim 7, wherein the plurality of electrode stacks are electrically coupled in series.

9. The metal hydrogen battery of claim 7, wherein the plurality of electrode stacks are electrically coupled in parallel.

10. The metal hydrogen battery of claim 7, wherein the plurality of electrode stacks are coupled partially in series and partially in parallel.

11. The metal hydrogen battery of claim 1, wherein the one or more pressure vessels includes a plurality of pressure vessels, at least one of the plurality of pressure vessels including a plurality of electrode stacks.

12. A method of operating a metal hydrogen battery, comprising:
providing hydrogen from a storage vessel to one or more pressure vessels, each of the one or more pressure vessels including one or more electrode stacks, with a control device coupled between the storage vessel and the one or more pressure vessels.

13. The method of claim 12, wherein a pressure of hydrogen in the one or more pressure vessels is less than 50 PSI.

14. The method of claim 12, wherein the one or more pressure vessels includes a plurality of pressure vessels, each of the plurality of pressure vessels including an electrode stack.

15. The method of claim 12, wherein the one or more pressure vessels including a pressure vessel that includes a plurality of electrode stacks.

16. The method of claim 12, wherein the one or more pressure vessels includes a plurality of pressure vessels, wherein at least one of the plurality of pressure vessels includes a plurality of electrode stacks.

17. A metal hydrogen battery, comprising:
means for providing hydrogen from a storage vessel to one or more pressure vessels, each of the one or more pressure vessels including one or more electrode stacks, with a control device coupled between the storage vessel and the one or more pressure vessels.
